(19) United States
(12) Patent Application Publication
(10) Pub. No.: US 2026/0222589 A1
(43) Pub. Date: Jul. 30, 2026

(54) Image stream transmission system, apparatus and method thereof having dynamic image encoding mechanism

(71) Applicant: REALTEK SEMICONDUCTOR CORPORATION, HSINCHU (TW)

(72) Inventor: Kai-Hsiang Chou, Hsinchu (TW)

(21) Appl. No.: 19/453,272

(22) Filed: Jan. 20, 2026

(30) Foreign Application Priority Data
Jan. 24, 2025 (TW) 114103666

(51) Int. Cl. H04N 19/146; A63F 13/355; A63F 13/358; A63F 13/52; H04N 19/172; H04N 19/513

(52) U.S. Cl. CPC H04N 19/146; A63F 13/355; A63F 13/358; A63F 13/52; H04N 19/172; H04N 19/513

(57) ABSTRACT

An image stream transmission apparatus having a dynamic image encoding mechanism is provided that includes an image encoding circuit, a communication circuit and a control circuit configured to perform steps outlined below. The image encoding circuit is controlled to generate test image frames having different test bit rates in an environment test stage. The communication circuit is controlled to transmit the test image frames to a remote apparatus through a network to be decoded and receive operation signals from the remote apparatus through the network. Round-trip times are calculated according to the transmission of the test image frames and the receiving of the operation signals. The image encoding circuit is controlled to determine an encoding strategy according to a smallest round-trip time and a decoding ability of the remote apparatus to generate and transmit game image frames to the remote apparatus in a game performing stage.

### BACKGROUND OF THE INVENTION

### 1. Field of the Invention

The present invention relates to an image stream transmission system, an image stream transmission apparatus and an image stream transmission method thereof having a dynamic image encoding mechanism.

### 2. Description of Related Art

The technology of cloud gaming allows all the operations required by the game performance to be executed on a cloud service, in which the images of the game are transmitted from the cloud server to the user terminal instantly. A player only needs to active the streaming application to play the game by using a computer, a tablet PC or a smartphone under the condition that the network environment is good enough. However, such a technology is limited by the delay generated from either the network or the insufficient speed of the image encoding and decoding. If the delay is too long, the experience of the player is affected.

### SUMMARY OF THE INVENTION

In consideration of the problem of the prior art, an object of the present invention is to supply an image stream transmission system, an image stream transmission apparatus and an image stream transmission method thereof having a dynamic image encoding mechanism.

The present invention discloses an image stream transmission apparatus having a dynamic image encoding mechanism that includes an image encoding circuit, a communication circuit and a control circuit. The control circuit is configured to control the image encoding circuit to generate a plurality of test image frames having different test bit rates in an environment test stage, control the communication circuit to transmit the test image frames through a network to a remote apparatus to be decoded and receive a plurality of operation signals from the remote apparatus through the network, calculate a plurality of test round-trip times according to the transmission of the test image frames and the receiving of the operation signals and control the image encoding circuit to determine an image encoding strategy according to a smallest test round-trip time of the test round-trip times and a decoding ability of the remote apparatus to generate and transmit a plurality of game image frames to the remote apparatus in a game performing stage.

The present invention also discloses an image stream transmission method having a dynamic image encoding mechanism that includes steps outlined below. An image encoding circuit is controlled to generate a plurality of test image frames having different test bit rates in an environment test stage by a control circuit. A communication circuit is controlled to transmit the test image frames through a network to a remote apparatus to be decoded and a plurality of operation signals are received from the remote apparatus through the network by the control circuit. A plurality of test round-trip times are calculated according to the transmission of the test image frames and the receiving of the operation signals by the control circuit. The image encoding circuit is controlled to determine an image encoding strategy according to a smallest test round-trip time of the test round-trip times and a decoding ability of the remote apparatus by the control circuit to generate and transmit a plurality of game image frames to the remote apparatus in a game performing stage.

The present invention further discloses an image stream transmission system that includes a remote apparatus and an image stream transmission apparatus. The image stream transmission apparatus includes an image encoding circuit, a communication circuit and a control circuit. The control circuit is configured to control the image encoding circuit to generate a plurality of test image frames having different test bit rates in an environment test stage, control the communication circuit to transmit the test image frames through a network to the remote apparatus to be decoded and receive a plurality of operation signals from the remote apparatus through the network, calculate a plurality of test round-trip times according to the transmission of the test image frames and the receiving of the operation signals and control the image encoding circuit to determine an image encoding strategy according to a smallest test round-trip time of the test round-trip times and a decoding ability of the remote apparatus to generate and transmit a plurality of game image frames to the remote apparatus in a game performing stage.

These and other objectives of the present invention will no doubt become obvious to those of ordinary skill in the art behind reading the following detailed description of the preferred embodiments that are illustrated in the various figures and drawings.

### BRIEF DESCRIPTION OF THE DRAWINGS

FIG. 1 illustrates a block diagram of an image stream transmission system according to an embodiment of the present invention.

FIG. 2 illustrates a flow chart of an image stream transmission method having a dynamic image encoding mechanism according to an embodiment of the present invention.

### DETAILED DESCRIPTION OF THE PREFERRED EMBODIMENTS

An aspect of the present invention is to provide an image stream transmission system, an image stream transmission apparatus and an image stream transmission method thereof having a dynamic image encoding mechanism to determine test round-trip times based on the transmission of test image frames in an environment test stage to further determine an image encoding strategy for the generation and transmission of game image frames in a game performing stage.

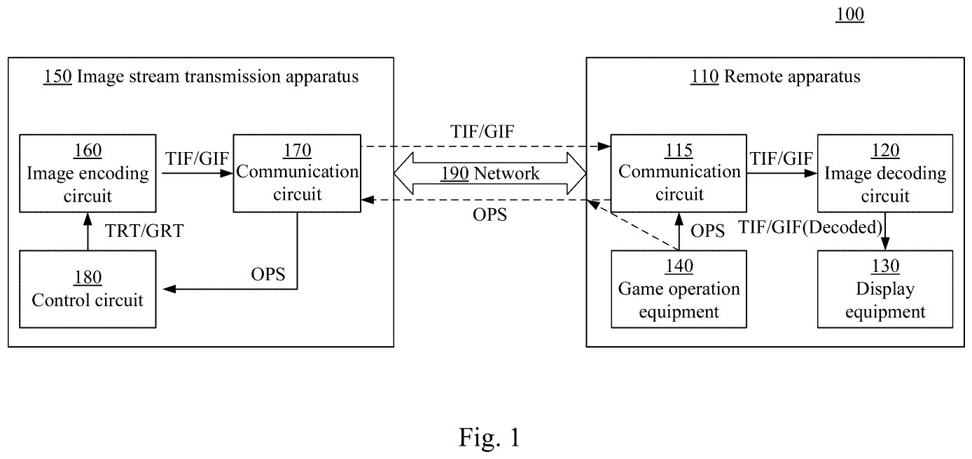

Reference is now made to FIG. 1. FIG. 1 illustrates a block diagram of a image stream transmission system 100 according to an embodiment of the present invention. The image stream transmission system 100 includes a remote apparatus 110 and an image stream transmission apparatus 150.

In an embodiment, the image stream transmission system 100 is a network streaming game system. The remote apparatus 110 operates as a user terminal, which is an apparatus operated by a player. The image stream transmission apparatus 150 operates as a host, which is an apparatus that provides game image frames GIF to the remote apparatus 110 through a network 190 based on the streaming service. Moreover, the image stream transmission apparatus 150 may receive operation signals OPS generated by the remote apparatus 110 based on the operation of the player through the network 190 to update the game image frames GIF according to the operation signals OPS. The image transmission may be performed with such as, but not limited to transmission formats of Transport Stream (TS) or HyperText Transfer Protocol Live Streaming (HLS), and compression formats corresponding to RGB or YUV after being decompressed. However, the present invention is not limited to a specific transmission format or a specific compression format.

In an embodiment, relative to the remote apparatus 110, the image stream transmission apparatus 150 can be a cloud apparatus or a game host having a close physical distance from the remote apparatus 110. The present invention is not limited to any specific disposition relation between the remote apparatus 110 and the image stream transmission apparatus 150. Further, the network 190 between the remote apparatus 110 and the image stream transmission apparatus 150 can be either wired or wireless to allow the remote apparatus 110 and the image stream transmission apparatus 150 to perform communication based on a wired network communication technology or a wireless network communication technology.

The remote apparatus 110 includes a communication circuit 115, an image decoding circuit 120, a display equipment 130 and a game operation equipment 140. The communication circuit 115 can be any circuit to perform communication based on a wired network communication technology or a wireless network communication technology. The image decoding circuit 120 is configured to receive the game image frames GIF through the communication circuit 115 and decode the game image frames GIF for the display equipment 130, e.g., a television, a tablet PC or other display apparatuses, to display.

The game operation equipment 140 can be such as, but not limited to joystick or a gamepad, and is configured to generate the operation signals OPS according to a key input or a motion input of a user.

In an embodiment, the display equipment 130 and the game operation equipment 140 may be integrated with the communication circuit 115 and the image decoding circuit 120 such that the remote apparatus 110 becomes a composite apparatus. In another embodiment, the display equipment 130 and the game operation equipment 140 may be disposed independently from the communication circuit 115 and the image decoding circuit 120 and are coupled to the communication circuit 115 and the image decoding circuit 120 through a wired or a wireless method. The present invention is not limited thereto.

In order to prevent the delay generated during the transmission of the game image frames GIF from affecting the user experience of the user of the remote apparatus 110, the image stream transmission apparatus 150 can be equipped with a dynamic image encoding mechanism to provide the game image frames GIF to the remote apparatus 110 according to an optimal encoding method. The configuration and the operation of the image stream transmission apparatus 150 are described in the following paragraph to further describe the operation of the dynamic image encoding mechanism.

The image stream transmission apparatus 150 includes an image encoding circuit 160, a communication circuit 170 and a control circuit 180.

The image encoding circuit 160 is configured to encode the image frames to be outputted according to different image encoding strategies. The communication circuit 170 can be a circuit using any wired or wireless network communication technology to perform communication with the remote apparatus 110.

The control circuit 180 is electrically coupled to the image encoding circuit 160 and the communication circuit 170 to control the image encoding circuit 160 and the communication circuit 170 to perform the operation of the dynamic image encoding mechanism. In an embodiment, the dynamic image encoding mechanism can be operated in an environment test stage and a game performing stage.

In the environment test stage, the control circuit 180 controls the image encoding circuit 160 to generate a plurality of test image frames TIF having a plurality of different test bit rates, in which the test bit rates can be such as, but not limited to 2500 kbps, 3500 kbps, 4000 kbps, 5000 kbps or other values.

The control circuit 180 controls the communication circuit 170 to transmit the test image frames TIF through the network 190 to the remote apparatus 110 to be decoded, and receives a plurality of operation signals OPS from the remote apparatus 110 through the network 190.

In an embodiment, the test image frames TIF can be received by the image decoding circuit 120 of the remote apparatus 110 through the communication circuit 115, decoded by image decoding circuit 120 and displayed by the display equipment 130 of the remote apparatus 110. Each of the test image frames TIF may include contents indicating the user to perform key input. As a result, in an embodiment, each of the operation signals OPS is a key input by a user to the game operation equipment 140 in response to the test image frames TIF.

The control circuit 180 calculates a plurality of test round-trip times TRT according to the transmission of the test image frames TIF and the receiving of the operation signals OPS.

In an embodiment, each of the test round-trip times TRT includes an image encoding time of the image encoding circuit 160, a network transmission time of the test image frames TIF, an image decoding time of the image decoding circuit 120 included by the remote apparatus 110, an operation signal generation time of the game operation equipment 140 included by the remote apparatus 110, an operation signals transmission time from a first moment that the game operation equipment 140 transmits the operation signals OPS to a second moment that the communication circuit 170 receives the operation signals OPS or a combination thereof.

In the times described above, the operation signal generation time of t game operation equipment 140 is a time from the moment that the user sees the test image frames TIF to the moment that the user presses the keys of the game operation equipment 140. The operation signals transmission time from the moment that the game operation equipment 140 transmits the operation signals OPS to the moment that the communication circuit 170 receives the operation signals OPS may be different according to the transmission method of the operation signals OPS. For example, the game operation equipment 140 may selectively transmit the operation signals OPS to the network 190 through the communication circuit 115 by using the solid line path in FIG. 1 so as to be received by the communication circuit 170. The game operation equipment 140 may also selectively transmit the operation signals OPS to the network 190 directly by using the dashed line path in FIG. 1 (e.g., transmit the operation signals OPS to a router) so as to be received by the communication circuit 170. The present invention is not limited thereto.

Take the condition that the image encoding time is E, the network transmission time is N, the image decoding time is D, the operation signal generation time is K, and the operation signals transmission time is F as an example, each of the test round-trip times TRT is E+N+D+K+F when all the times described above are taken into consideration.

The control circuit 180 controls the image encoding circuit 160 to determine an image encoding strategy according to a smallest test round-trip time of the test round-trip times TRT and a decoding ability of the remote apparatus 110 to generate and transmit the game image frames GIF to the remote apparatus 110 in the game performing stage.

In an embodiment, the decoding ability of the remote apparatus 110 includes a number of supported image encoding formats of the remote apparatus 110, a decoding rate of the remote apparatus 110 or a combination thereof. In an embodiment, the control circuit 180 performs a handshake process with the remote apparatus 110 through the communication circuit 170 before transmitting the test image frames TIF to retrieve the decoding ability of the remote apparatus 110.

In an embodiment, the image encoding strategy includes an image bit rate, an image resolution, an image frame rate, a color space, an image frame referencing method, a compression rate or a combination thereof.

For example, the smallest test round-trip time that is located within a first value range with relatively smaller values stands for a smaller delay of the communication performed between the image stream transmission apparatus 150 and the remote apparatus 110. The control circuit 180 may control the image encoding circuit 160 to determine an image encoding strategy corresponding to an image encoding algorithm supported by the decoding ability of the remote apparatus 110 having a larger image bit rate, a higher image resolution, a higher image frame rate, a color space with more color information, an interframe coding with more reference images, an intraframe coding with a reference of the frame itself to be encoded, a smaller compression rate or a combination thereof.

The smallest test round-trip time that is located within a second value range with relatively larger values stands for a larger delay of the communication performed between the image stream transmission apparatus 150 and the remote apparatus 110. The control circuit 180 may control the image encoding circuit 160 to determine an image encoding strategy corresponding to an image encoding algorithm supported by the decoding ability of the remote apparatus 110 having a smaller image bit rate, a lower image resolution, a lower image frame rate, a color space with less color information, an interframe coding with less reference images, a larger compression rate or a combination thereof.

As a result, in the environment test stage, the control circuit 180 may control the image encoding circuit 160 to determine the image encoding strategy according to the smallest test round-trip time and the decoding ability of the remote apparatus 110 by using the process described above. The image encoding circuit 160 may generate and transmit the game image frames GIF in the game performing stage according to the image encoding strategy determined in the environment test stage.

It is appreciated that in an embodiment, among the times used to determine the amount of the test round-trip times TRT, the image encoding time, the network transmission time, the image decoding time and the operation signals transmission time are variants. The operation signal generation time can be a constant. In an embodiment, the control circuit 180 may obtain the image encoding time, the network transmission time and the image decoding time from the content of the operation signals OPS or other signals generated by the remote apparatus 110, and further obtain the operation signal generation time from the difference between the test round-trip times TRT and the sum of the times described above. In an embodiment, when the degree that the operation signal generation time is larger than other times exceeds a threshold value, i.e., the reaction of the user is slow enough to make the total test round-trip time TRT become too large, the control circuit 180 may directly control the image encoding circuit 160 to use a predetermined image encoding strategy.

In the game performing stage, the control circuit 180 may further adjust the image encoding strategy based on the condition of the game performance.

In an embodiment, in the game performing stage, the control circuit 180 determines a game round-trip time GRT according to the game image frames GIF. The determination of the game round-trip time GRT is identical to the determination of the test round-trip times TRT. The detail is not described herein.

Furthermore, the control circuit 180 may control the image encoding circuit 160 to adjust the image encoding strategy according to the game round-trip time GRT and the decoding ability of the remote apparatus 110, in which the adjustment of the image encoding strategy is identical to the adjustment of the image encoding strategy in the environment test stage described above. The detail is not described herein.

In an embodiment, in the game performing stage, the control circuit 180 may determine a plurality of game complexity parameters according to the game image frames GIF to further determine a game type. Moreover, the control circuit 180 may control the image encoding circuit 160 to adjust the image encoding strategy according to the game type.

In an embodiment, the game complexity parameters include an image motion vector number, an image motion vector distance, a player key operating frequency or a combination thereof such that the control circuit 180 determines the game type accordingly.

In an embodiment, the control circuit 180 is configured to determine that the image motion vector number is larger than a predetermined number, the image motion vector distance is larger than a predetermined number, a player key operating time interval is smaller than a predetermined interval or a combination thereof so as to determine that the game type is an action game type.

In an embodiment, the control circuit 180 is configured to determine that a complexity evaluation value of the game complexity parameters is larger than a predetermined value so as to determine that the game type is an action game type. The complexity evaluation value may be a value calculated according to the image motion vector number, the image motion vector distance and the player key operating time interval.

For example, when the image motion vector number is M and a corresponding weighting parameter is a, the image motion vector distance is A and a corresponding weighting parameter is b, and the player key operating time interval is T and a corresponding weighting parameter is c, the complexity evaluation value is calculated by adding the image motion vector number that is weighted and the image motion vector distance that is weighted and subtracting the player key operating time interval that is weighted, which is a×M+b×A−c×T.

As a result, the control circuit 180 may determine whether the game type is the action game type according to any one of the parameters described, according to any combination of the parameters described (e.g., the complexity evaluation value described above) or simultaneously according to the parameters and the combination of the parameters described.

The control circuit 180 determines that the game type is the action game type to control the image encoding circuit 160 to adjust the image encoding strategy to increase a display fluency. More specifically, the control circuit 180 may control the image encoding circuit 160 to adjust the image encoding strategy that includes the image bit rate, the image resolution, the image frame rate, the color space, the image frame referencing method, the compression rate or a combination thereof to increase the display fluency.

For example, the control circuit 180 may determine that the speed of the network 190 is slower according to the test round-trip times TRT or the game round-trip time GRT so as to control the image encoding circuit 160 to adjust the image encoding strategy to have a lower image bit rate. The control circuit 180 may determine that the speed of the network 190 is higher and the decoding ability of the remote apparatus 110 is better so as to control the image encoding circuit 160 to adjust the image encoding strategy to use the intraframe coding that only uses I frame as the reference. Besides, for the action game type, the control circuit 180 may directly increase the image frame rate, e.g., from 60 frame per second (fps) to 120 fps.

It is appreciated that the adjustment methods of the image encoding strategy described above are only a few possible options. The present invention is not limited to a specific adjustment method of the image encoding strategy.

On the other hand, the control circuit 180 may determine that the game type is an non-action game type so as to control the image encoding circuit 160 to adjust the image encoding strategy to dynamically increase the image quality, such as but not limited to using an image encoding strategy having Low Complexity Enhancement Image Coding (LCEVC) to compensate for the loss of the conversion from YUV420 to RGB888. The present invention is not limited to a specific adjustment method of the image encoding strategy.

The image stream transmission apparatus having a dynamic image encoding mechanism of the present invention determines the test round-trip times based on the transmission of test image frames in the environment test stage to further determine the image encoding strategy for the generation and transmission of game image frames in the game performing stage.

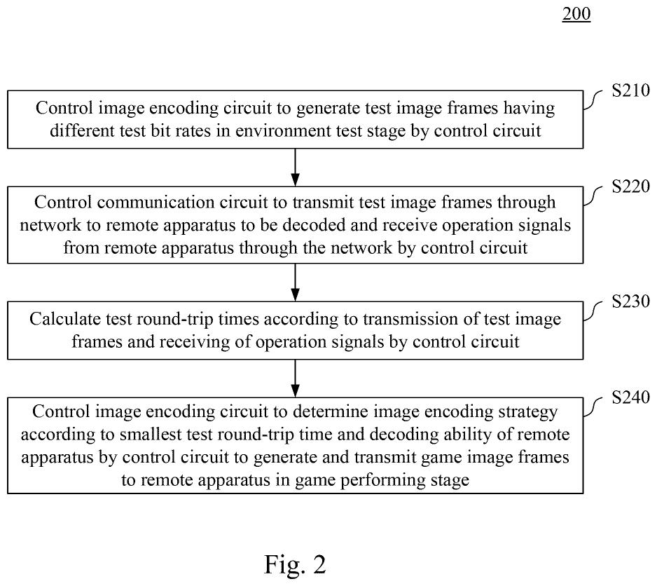

Reference is now made to FIG. 2. FIG. 2 illustrates a flow chart of an image stream transmission method 200 having a dynamic image encoding mechanism according to an embodiment of the present invention.

In addition to the apparatus described above, the present disclosure further provides the image stream transmission method 200 having the dynamic image encoding mechanism that can be used in such as, but not limited to, the image stream transmission apparatus 150 in FIG. 1. As illustrated in FIG. 2, an embodiment of the image stream transmission method 200 includes the following steps.

In step S210, the image encoding circuit 160 is controlled to generate the test image frames TIF having different test bit rates in the environment test stage by the control circuit 180.

In step S220, the communication circuit 170 is controlled to transmit the test image frames TIF through the network 190 to the remote apparatus 110 to be decoded and the operation signals OPS are received from the remote apparatus 110 through the network 190 by the control circuit 180.

In step S230, the test round-trip times TRT are calculated according to the transmission of the test image frames TIF and the receiving of the operation signals OPS by the control circuit 180.

In step S240, the image encoding circuit 160 is controlled to determine the image encoding strategy according to the smallest test round-trip time of the test round-trip times TRT and the decoding ability of the remote apparatus 110 by the control circuit 180 to generate and transmit the game image frames GIF to the remote apparatus 110 in the game performing stage.

It is appreciated that the embodiments described above are merely an example. In other embodiments, it should be appreciated that many modifications and changes may be made by those of ordinary skill in the art without departing, from the spirit of the disclosure.

In summary, the present invention discloses the image stream transmission system, the image stream transmission apparatus and the image stream transmission method thereof having the dynamic image encoding mechanism to determine the test round-trip times based on the transmission of test image frames in the environment test stage to further determine the image encoding strategy for the generation and transmission of game image frames in the game performing stage.

The aforementioned descriptions represent merely the preferred embodiment of the present invention, without any intention to limit the scope of the present invention thereto. Various equivalent changes, alterations, or modifications based on the claims of present invention are all consequently viewed as being embraced by the scope of the present invention.

What is claimed is:

1. An image stream transmission apparatus having a dynamic image encoding mechanism, comprising:
an image encoding circuit;
a communication circuit; and
a control circuit configured to:
control the image encoding circuit to generate a plurality of test image frames having different test bit rates in an environment test stage;
control the communication circuit to transmit the test image frames through a network to a remote apparatus to be decoded and receive a plurality of operation signals from the remote apparatus through the network;
calculate a plurality of test round-trip times according to the transmission of the test image frames and the receiving of the operation signals; and
control the image encoding circuit to determine an image encoding strategy according to a smallest test round-trip time of the test round-trip times and a decoding ability of the remote apparatus to generate and transmit a plurality of game image frames to the remote apparatus in a game performing stage.

2. The image stream transmission apparatus of claim 1, wherein the control circuit is further configured to:
determine a plurality of game complexity parameters according to the game image frames in the game performing stage to further determine a game type; and
control the image encoding circuit to adjust the image encoding strategy according to the game type.

3. The image stream transmission apparatus of claim 2, wherein the game complexity parameters comprise an image motion vector number, an image motion vector distance, a player key operating frequency or a combination thereof, and the control circuit is further configured to:
determine that the image motion vector number is larger than a predetermined number, the image motion vector distance is larger than a predetermined number, a player key operating time interval is smaller than a predetermined interval, a complexity evaluation value of the game complexity parameters is larger than a predetermined value or a combination thereof so as to determine that the game type is an action game type, and further control the image encoding circuit to adjust the image encoding strategy to increase a display fluency, wherein the complexity evaluation value is calculated by adding the image motion vector number that is weighted and the image motion vector distance that is weighted and subtracting the player key operating time interval that is weighted.

4. The image stream transmission apparatus of claim 1, wherein the control circuit is further configured to:
determine a game round-trip time according to the game image frames in the game performing stage; and
control the image encoding circuit to adjust the image encoding strategy according to the game round-trip time and the decoding ability of the remote apparatus.

5. The image stream transmission apparatus of claim 1, wherein the image encoding strategy comprises an image bit rate, an image resolution, an image frame rate, a color space, an image frame referencing method, a compression rate or a combination thereof.

6. The image stream transmission apparatus of claim 1, wherein each of the test round-trip times comprises an image encoding time of the image encoding circuit, a network transmission time of the test image frames, an image decoding time of an image decoding circuit comprised by the remote apparatus, an operation signal generation time of a game operation equipment comprised by the remote apparatus, an operation signals transmission time from a first moment that the game operation equipment transmits the operation signals from a second moment that the communication circuit receives the operation signals or a combination thereof.

7. The image stream transmission apparatus of claim 6, wherein each of the operation signals is a key input by a user to the game operation equipment in response to the test image frames.

8. The image stream transmission apparatus of claim 1, wherein the decoding ability of the remote apparatus comprises a number of supported image encoding formats of the remote apparatus, a decoding rate of the remote apparatus or a combination thereof, and the control circuit performs a handshake process with the remote apparatus through the communication circuit to retrieve the decoding ability of the remote apparatus.

9. An image stream transmission method having a dynamic image encoding mechanism, comprising:
controlling an image encoding circuit to generate a plurality of test image frames having different test bit rates in an environment test stage by a control circuit;
controlling a communication circuit to transmit the test image frames through a network to a remote apparatus to be decoded and receiving a plurality of operation signals from the remote apparatus through the network by the control circuit;
calculating a plurality of test round-trip times according to the transmission of the test image frames and the receiving of the operation signals by the control circuit; and
controlling the image encoding circuit to determine an image encoding strategy according to a smallest test round-trip time of the test round-trip times and a decoding ability of the remote apparatus by the control circuit to generate and transmit a plurality of game image frames to the remote apparatus in a game performing stage.

10. The image stream transmission method of claim 9, further comprising:
determining a plurality of game complexity parameters according to the game image frames in the game performing stage by the control circuit to further determine a game type; and
controlling the image encoding circuit to adjust the image encoding strategy according to the game type by the control circuit.

11. The image stream transmission method of claim 10, wherein the game complexity parameters comprise an image motion vector number, an image motion vector distance, a player key operating frequency or a combination thereof, the image stream transmission method further comprises:
determining that the image motion vector number is larger than a predetermined number, the image motion vector distance is larger than a predetermined number, a player key operating time interval is smaller than a predetermined interval, a complexity evaluation value of the game complexity parameters is larger than a predetermined value or a combination thereof by the control circuit so as to determine that the game type is an action game type, and further control the image encoding circuit to adjust the image encoding strategy to increase a display fluency, wherein the complexity evaluation value is calculated by adding the image motion vector number that is weighted and the image motion vector distance that is weighted and subtracting the player key operating time interval that is weighted.

12. The image stream transmission method of claim 9, further comprising:
determining a game round-trip time according to the game image frames in the game performing stage by the control circuit; and
controlling the image encoding circuit to adjust the image encoding strategy according to the game round-trip time and the decoding ability of the remote apparatus by the control circuit.

13. The image stream transmission method of claim 9, wherein the image encoding strategy comprises an image bit rate, an image resolution, an image frame rate, a color space, an image frame referencing method, a compression rate or a combination thereof.

14. The image stream transmission method of claim 9, wherein each of the test round-trip times comprises an image encoding time of the image encoding circuit, a network transmission time of the test image frames, an image decoding time of an image decoding circuit comprised by the remote apparatus, an operation signal generation time of a game operation equipment comprised by the remote apparatus, an operation signals transmission time from a first moment that the game operation equipment transmits the operation signals from a second moment that the communication circuit receives the operation signals or a combination thereof.

15. The image stream transmission method of claim 14, wherein each of the operation signals is a key input by a user to the game operation equipment in response to the test image frames.

16. The image stream transmission method of claim 9, wherein the decoding ability of the remote apparatus comprises a number of supported image encoding formats of the remote apparatus, a decoding rate of the remote apparatus or a combination thereof, and the image stream transmission method further comprises:
performing a handshake process with the remote apparatus through the communication circuit to retrieve the decoding ability of the remote apparatus by the control circuit.

17. An image stream transmission system, comprising:
a remote apparatus; and
an image stream transmission apparatus comprising:
an image encoding circuit;
a communication circuit; and
a control circuit, configured to:
control the image encoding circuit to generate a plurality of test image frames having different test bit rates in an environment test stage;
control the communication circuit to transmit the test image frames through a network to the remote apparatus to be decoded and receive a plurality of operation signals from the remote apparatus through the network;
calculate a plurality of test round-trip times according to the transmission of the test image frames and the receiving of the operation signals; and
control the image encoding circuit to determine an image encoding strategy according to a smallest test round-trip time of the test round-trip times and a decoding ability of the remote apparatus to generate and transmit a plurality of game image frames to the remote apparatus in a game performing stage.

18. The image stream transmission system of claim 17, wherein the control circuit is further configured to:
determine a plurality of game complexity parameters according to the game image frames in the game performing stage to further determine a game type; and
control the image encoding circuit to adjust the image encoding strategy according to the game type.

19. The image stream transmission system of claim 18, wherein the game complexity parameters comprise an image motion vector number, an image motion vector distance, a player key operating frequency or a combination thereof, and the control circuit is further configured to:
determine that the image motion vector number is larger than a predetermined number, the image motion vector distance is larger than a predetermined number, a player key operating time interval is smaller than a predetermined interval, a complexity evaluation value of the game complexity parameters is larger than a predetermined value or a combination thereof so as to determine that the game type is an action game type, and further control the image encoding circuit to adjust the image encoding strategy to increase a display fluency, wherein the complexity evaluation value is calculated by adding the image motion vector number that is weighted and the image motion vector distance that is weighted and subtracting the player key operating time interval that is weighted.

20. The image stream transmission system of claim 17, wherein the control circuit is further configured to:
determine a game round-trip time according to the game image frames in the game performing stage; and
control the image encoding circuit to adjust the image encoding strategy according to the game round-trip time and the decoding ability of the remote apparatus.
